(19) United States
(12) Patent Application Publication
(10) Pub. No.: US 2004/0074834 A1
(43) Pub. Date: Apr. 22, 2004

(54) Modular aquaculture filtration system

(76) Inventors: Gregory Alan Beckman, Louisiana, LA (US); Glenn Roger Snapp, Louisiana, LA (US); Terrence Robert McCarthy, Louisiana, LA (US)

Correspondence Address: Clinton R. Stuart, P.O. Box 4412, Baton Rouge, LA, 70821-4412, US

(21) Appl. No.: 10/618,550

(22) Filed: Jul. 11, 2003

Related U.S. Application Data
(60) Provisional application No. 60/395,528, filed on Jul. 12, 2002.

(51) Int. Cl. B01D 25/00

(52) U.S. Cl. 210/323.1

(57) ABSTRACT

The Modular Aquaculture Filtration System (“MAFS”) employs small modular filtration units which may be linked together to form larger filters of a particular type or combined to form filtration systems with various types of filters. In essence, two or more modular filtration units are interlocked together to form a single cell system for processing water from aquaculture tanks. The modular units are each comprised of a housing, which includes a means for rigidly attaching/interlocking one housing to another housing, and a one or more of several different types of filtration techniques. Thus, the modular filtration units act as the building blocks for constructing larger filters of a particular type, by interlocking several MAFS of the same type together, or for constructing filter systems that employ several different filtration techniques. The modular approach of the MAFS provides a level of flexibility heretofore unavailable for filtration systems in the aquaculture industry.

### BACKGROUND OF THE INVENTION

Aquaculture facilities typically utilize filtration systems, since the water in the various holding tanks must be regularly filtered to clean out waste byproducts. Standard aquaculture filtration systems are component-style systems, which link several independent, stand-alone filter vessels together via piping. Unfortunately, such standard component-style filter systems typically include several vessels that are quite large, making installation of such systems difficult in buildings with standard double door openings. Furthermore, these systems may not be easily upgraded when the aquaculture facility's needs change, since any change to the systems would require the addition of extra filtration vessels and rerouting of existing piping so that the plumbing will accommodate the new fluid flow through the altered system. These standard component-style filter systems are typically individually designed for a facility, such that they may not be easily modified. And obviously, such component-style filtration systems take up a great deal of space. Thus, there is a need for an aquaculture filtration system that is modular in approach and compact in design.

The present invention of the Modular Aquaculture Filtration System (“MAFS”) provides many advantages over the existing component-style filtration systems, making it better suited for industrial use in the field of aquaculture. The MAFS employs a modular filter design, with smaller, modular filtration units capable of being joined into a single cell filtration system. These smaller, modular filtration units act as the building blocks for the overall MAFS, which can be specifically configured as needed for the particular job. This modular approach allows for easy installation, due to the small size of each of the modular units, as well as convenient modification and upgrading of system capabilities, by simply adding on additional modular units to those already in place. Also, the modular approach allows for the use of standardized components, improving reliability and ease of manufacture, while assisting in convenience. Furthermore, since the MAFS does not require piping to transmit fluid from one filter process to the next, it is much more compact in design, allowing for more efficient use of space. Thus, the MAFS represents a vast improvement in aquaculture filtration system technology. While the present invention is particularly well-suited to aquaculture filtration, it is in no way limited to this field, and the modular approach of the MAFS may be used for other purposes.

### SUMMARY OF THE INVENTION

The Modular AquaCulture Filtration System (“MAFS”) is essentially comprised of two or more modular filtration units, which are rigidly joined together into a single unit to form a single cell filtration system. In other words, smaller, modular units are connected to form a single volume body. Thus, a single cell filtration system, with one or more types of filtration processes of various sizes, may be constructed using modular filtration units as the building blocks. The modular filtration units are joined together in such a way that they form an integrated whole, a filtration system that is self-contained and processes fluid without the need for piping or any other sort of fluid conduit transferring the fluid from one filtration process to the next. In other words, the entire multi-stage filtration process can take place within a single enclosure simply by fluid flow through the various modular filtration units of the single cell enclosure (as each modular filtration unit is in direct fluid contact with another modular unit).

Each modular filtration unit is further comprised of a housing and some internal filtration elements. There are various different types of filtration elements and configurations possible within the housing for a modular unit, depending upon the type of filtration desired. The means for rigidly joining the modular units together involves locking the housing of the component modular units together, so that they form a single cell that acts as an integrated whole, with a continuous external housing serving as an encompassing enclosure wall and containing the entire MAFS. Thus, the housings of the modular filtration units act as building blocks, forming the single cell enclosure for the entire MAFS. And because the modular filtration units are attached together to form a single cell unit, with direct fluid flow from one modular filtration unit to the succeeding modular filtration unit, there is no need for the type of piping required by component-style systems.

The housing of each modular filtration unit is designed to allow for integrated connection of the modular units into a single whole. The housings are typically sized so that they will fit through conventional double doors, making installation convenient. By combining several modular filtration units, however, the overall filtration effect of a single large filter may be achieved. Furthermore, while the housings may be made of any non-toxic solid material that is sufficiently non-porous so that water will not seep through it, typically the housings are made of fibreglass reinforced plastic. The housings are designed to allow for modular attachment, so that a plurality of modular filtration units may be joined to meet the filtration requirements of a particular aquaculture system. Typically, the housings provide for attachment/joinder by incorporating connective flanges in either the horizontal or vertical planes. Then, the connective flanges for a pair of modular filtration units would be mated together and securely fastened to lock the modular filtration units into place together.

The housing for internal modular filtration units is slightly different than that for external (or end piece) modular filtration units, since end piece units must also incorporate an additional wall to complete the enclosure. Internal modular filtration units employ a housing with one open side (that is, they have a front, a bottom, and two sides, but no back, for instance); this open configuration allows for the single cell approach when the modular units are connected together, since there will be direct fluid flow between modular units, which share a common wall. End pieces, however, must by necessity include an additional sidewall, in order to form a closed system. Typically, the modular filtration units do not include top covers, instead remaining open at the top, but covers could certainly be included as well.

The modular, connective nature of the housing for the modular units of the MAFS allows for a plurality of filter configurations and a plurality of filter sizes. Several modular filtration units of the same type could be connected together in order to form a larger filter size of a particular type, or several different types of modular filtration units could be connected together in different orders to form different filter configurations. In this way, the MAFS provides a flexible, customizable approach to aquaculture filtration. Modification or upgrading of an existing MAFS filter system may also be easily accomplished by adding modules, without compromising the overall “single volume body.” The modular approach of the MAFS allows the building block modular filtration units to be simply supplemented or rearranged, as needed.

Each of the modular filtration units includes within its housing some sort of filtration element. In other words, the internal workings of a particular modular filtration unit would employ one of several known filtration techniques to clean fluid flowing through the unit. While any filtration technique could be used within a modular filtration system, typical techniques would include mechanical solids filtration, foam fractionation-protein skimming, carbon dioxide removal, biological filtration (nitrification and de-nitrification), oxygen injection, UV sterilization, Ozone sterilization, and fine solids polishing filtration. Modular filtration units may include these and other filtration techniques.

The connective structure of the MAFS allows for many different types of overall filters, allowing users to customize the unit for their specific needs. The most typical types of uses for the MAFS within the aquaculture field, however, involve recycling systems and systems for pre-treatment of incoming water (flowing into an aquaculture tank) or treatment of effluent discharge from an aquaculture tank. Recycling systems are attached to aquaculture tanks and regularly filter the water in said tanks in a cyclical manner for reuse in the aquaculture tanks. Pre-treatment or effluent water treatment systems treat water only once (i.e. they are uni-directional). In either case, various filtration modules may be used in various arrangements, depending upon the specific needs of the system being serviced. In this way, the MAFS provides a very flexible filtration approach.

It is an object of the MAFS to filter the fluid in an aquaculture system. It is another object of MAFS to provide for convenient installation. It is yet another object to provide for a flexible filtration system, that can be customized, expanded, and upgraded easily. It is yet another object to employ a condensed designed, so that not much industrial space is required for the MAFS. It is yet another object to maintain a single cell or single volume body approach, so that fluid is directly transferred from one filtration process to the next without the need for piping. These and other objects will be readily apparent to persons of skill in the art field.

### BRIEF DESCRIPTION OF DRAWING

Reference will be made to the drawings, where like parts are designated by like numerals and wherein:

FIG. 1 is an illustrative drawing of the preferred embodiment of the MAFS, configured as a recycle system for cyclically treating water in an aquaculture tank on a continuous basis;

FIG. 2 is a blown apart, cut-away drawing of the preferred embodiment of the MAFS, configured as a recycle system;

FIG. 3 is a schematic fluid flow diagram showing the process flow through the preferred embodiment of the MAFS when configured as a recycle system;

FIG. 4 is a series of sectional drawings of the preferred flange and bolt technique for linking modular filtration units together, with FIG. 4A showing the two separate flanges on two separate modular filtration units, FIG. 4B showing the flanges bolted together to link the modular filtration units together, and FIG. 4C showing an enlarged view of the linked flanges with bolts and a sealing gasket;

FIG. 5 is a series of drawings of the flange technique for linking a modular filtration unit to a concrete unit, with FIG. 5A showing a FRP modular filtration unit flange connecting to a concrete unit, and FIG. 5B showing an enlarged view of the bolt connection means and sealing gasket;

FIG. 6 is a series of drawings of the alternative sliding flange technique for linking modular filtration units, with FIG. 6A showing the two separate slotted and sliding flanges on two separate modular filtration units, and FIG. 6B showing the manner in which these sliding slotted flanges mate;

FIG. 7 is a series of drawings of the preferred embodiment of the CO2 stripper module, with FIG. 7A showing the shell housing, FIG. 7B showing a cut-away isometric view of the CO2 stripper, and FIG. 7C showing a cut-away side view of the CO2 stripper;

FIG. 8 is a series of drawings of the preferred embodiment of the Foam Fractionation module, with FIG. 8A showing a cut-away isometric revealing the internal structure of the module, FIG. 8B showing an isometric view, and FIG. 8C showing a cut-away side view;

FIG. 9 is a series of drawings of the preferred embodiment of the Biofilter module, with FIG. 9A showing an isometric view, FIG. 9B showing a cut-away side view, and FIG. 9C showing an isometric internal view of three connected biofilter modules;

FIG. 10 is a series of drawings of the preferred embodiment of the Ultra-violet light and low head oxygenator module, with FIG. 10A showing the housing, FIG. 10B showing an isometric view of the module, and FIG. 10C showing a side view of the module; and

FIG. 11 is an illustrative drawing of the preferred embodiment of the MAFS configured to pre-treat incoming water or to treat effluent discharge.

### DETAILED DESCRIPTION OF PREFERRED EMBODIMENT

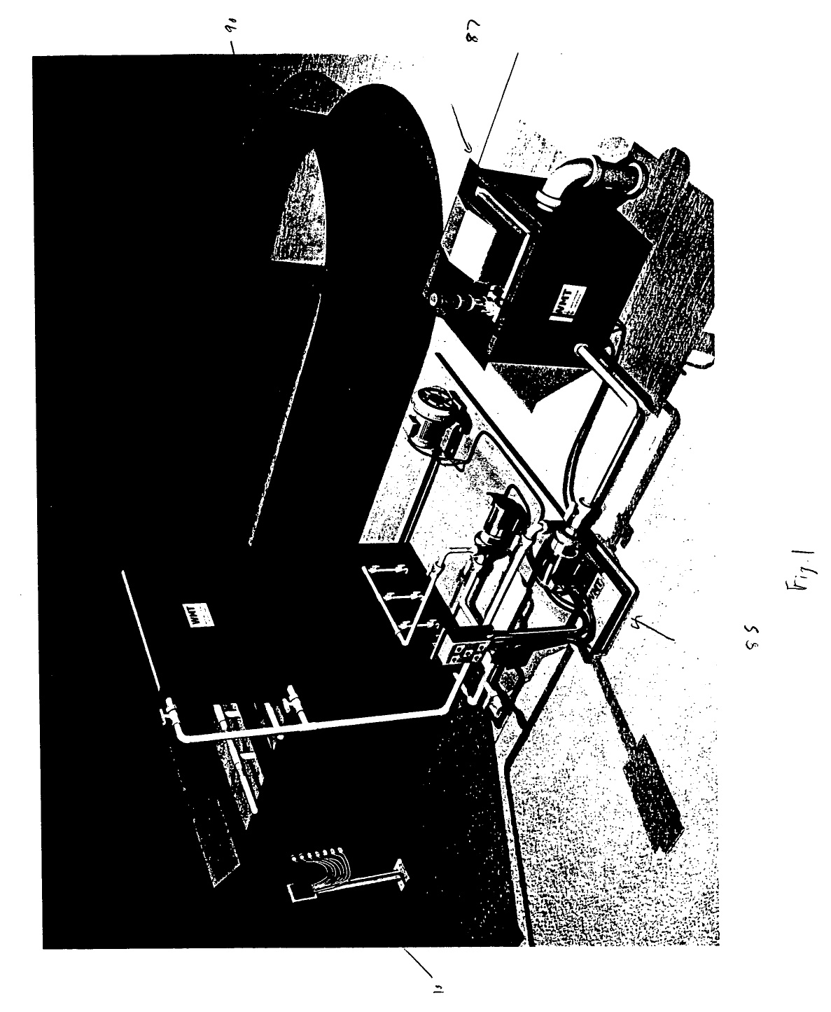

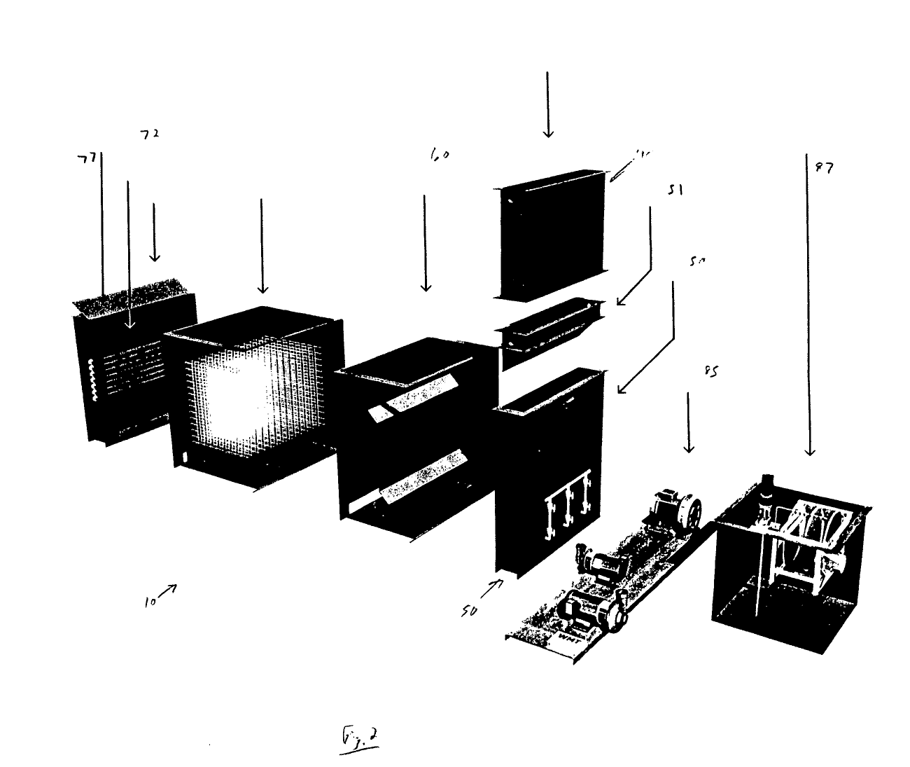

Referring now to the drawings in more detail, the preferred embodiment of MAFS, configured as a recycle system for continuously filtering the water in an aquaculture tank, is shown in FIGS. 1 and 2 and is generally designated by the numeral 10. FIG. 1 shows the MAFS 10 connected to an aquaculture tank 90, while FIG. 2 shows the component elements of the MAFS 10 blown-apart and cut-away to provide a better view of the preferred embodiment of the MAFS 10.

In its most basic form, the Modular AquaCulture Filtration System (“MAFS”) is essentially comprised of two or more modular filtration units, which are rigidly joined together into a single, integrated unit to form a single cell filtration system. In other words, smaller, modular units are connected together to form a single volume body that encloses the water being processed. Or stated another way, a large “single volume body” is constructed using a plurality of smaller modular filtration units interlocked together. Thus, a single cell filtration system, with one or more types of filtration processes of various sizes, may be constructed using modular filtration units as the basic building blocks. The modular filtration units are joined together in such a way that they form an integrated whole, a filtration system that is self-contained and processes fluid without the need for piping or any other sort of fluid conduit transferring the fluid from one filtration process to the next. In other words, the entire multi-stage filtration process can take place within a single enclosure simply by fluid flow through the various modular filtration units of the single cell enclosure (as each modular filtration unit is in direct fluid contact with another modular unit, acting only as sub-compartments in the overall single volume body).

Each modular filtration unit is further comprised of a housing and some type of filtration process element. There are various different types of filtration elements and configurations possible within the housing for a modular unit, depending upon the type of filtration desired. Thus, a modular filtration unit may be configured to utilize any of several well-known filtration techniques, depending upon the filtration elements located within the housing (i.e. by altering the filtration elements within the housing of a modular filtration unit, the specific filtration process employed by that particular modular filtration unit may be modified). The means for rigidly joining the modular units together involves locking the housing of the component modular units together, so that they form a single cell that acts as an integrated whole, with a continuous external housing serving as an encompassing enclosure wall and containing the entire MAFS 10. Thus, the housings of the modular filtration units act as building blocks, jointly forming the single cell enclosure for the entire MAFS 10 when linked together. And because the modular filtration units are attached together to form a single cell unit, with direct fluid flow from one modular filtration unit to the succeeding modular filtration unit, there is no need for the type of piping required by component-style systems. The “single volume body” approach of the MAFS 10 reduces the space requirements for the invention.

The housing of each modular filtration unit is designed to allow for integrated connection of the modular units into a single, integrated whole. The housings are typically sized so that they will fit through conventional double doors, making installation convenient. Furthermore, while the housings may be made of any non-toxic, non-degradable, solid material that is sufficiently non-porous so that water will not seep through it, in the preferred embodiment the housing for each modular filtration unit is made of fibreglass reinforced plastic. This produces a durable yet light-weight housing, convenient for installation. Alternatively, in some versions of the preferred embodiment, certain modular filtration unit housings are constructed of concrete. Such concrete modular filtration units could be used in conjunction with other concrete modular filtration units, or in conjunction with fibreglass reinforced plastic modular filtration units.

The housings for internal modular filtration units (i.e. modular filtration units other than end units) are slightly different than those for external (or end piece) modular filtration units, since end piece units must also incorporate an additional wall to complete the enclosure (creating the single cell unit required for the “single volume body” design concept). Internal modular filtration units employ a housing with one open side (that is, they have a front wall, a bottom, and two side walls, but no back wall, for instance); this open configuration allows for the single cell approach when the modular units are connected together, since there will be direct fluid flow between modular units. Attached modular filtration units share a common wall when joined together, with the front wall of one unit acting as the back wall for the preceding unit, for example. End pieces, however, must by necessity include an additional wall (typically a back wall), in order to form the closed system required for the “single volume body” approach. The housing for each modular filtration unit will typically have an inlet/outlet opening in one of its walls, providing direct fluid flow between interconnected modular filtration units (so that a “single volume body” is formed).

The housings are designed to allow for modular attachment, so that a plurality of modular filtration units may be joined to meet the filtration requirements of a particular aquaculture system. The housings are designed to include a means for rigidly locking a preceding housing to a succeeding housing, so that they act as a single continuous housing. Typically, the housings provide for attachment/joinder by incorporating connective flanges 20 in either the horizontal or vertical planes (depending on the desired direction for attaching modular filtration units). Then, the connective flanges 20 for a pair of modular filtration units would be mated together and securely fastened to lock the modular filtration units into place together. In this way, two modular filtration units may be rigidly locked into place together. This process is repeated as desired until the single cell unit (an enclosed system with all of the desired filtration processes) is formed.

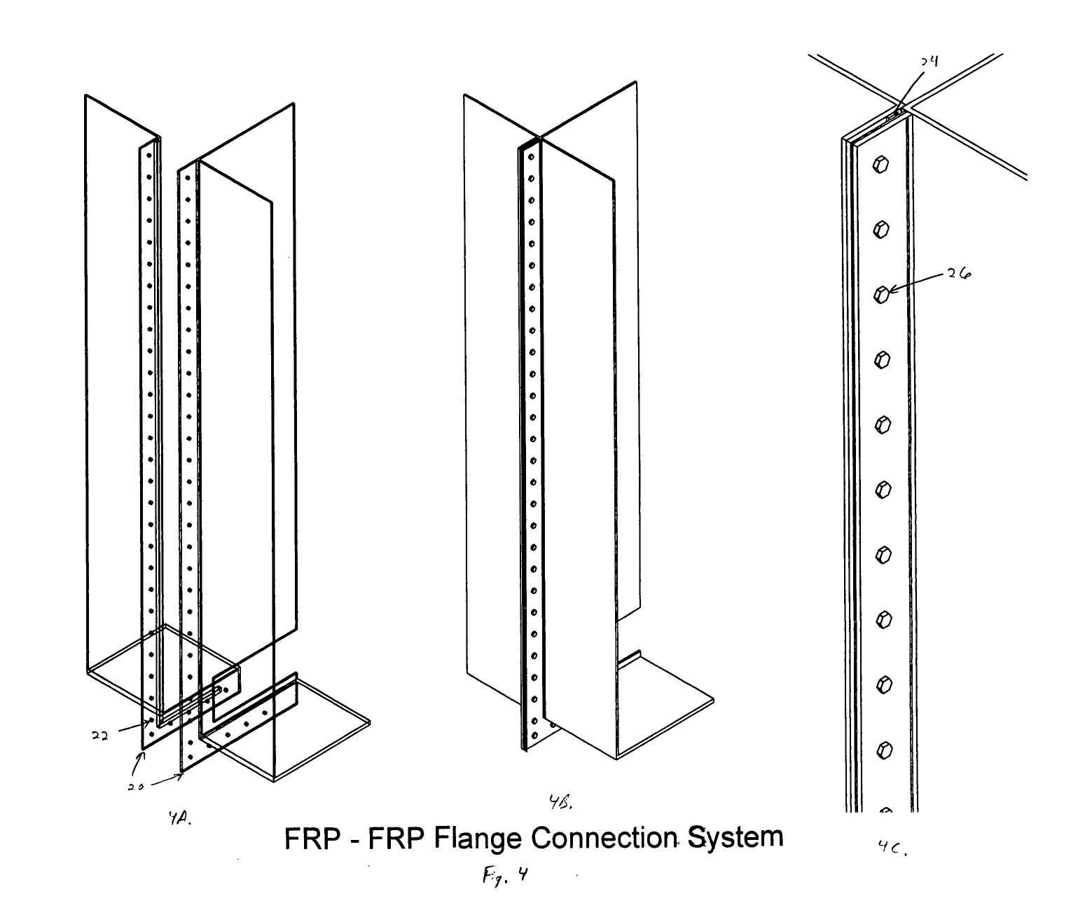

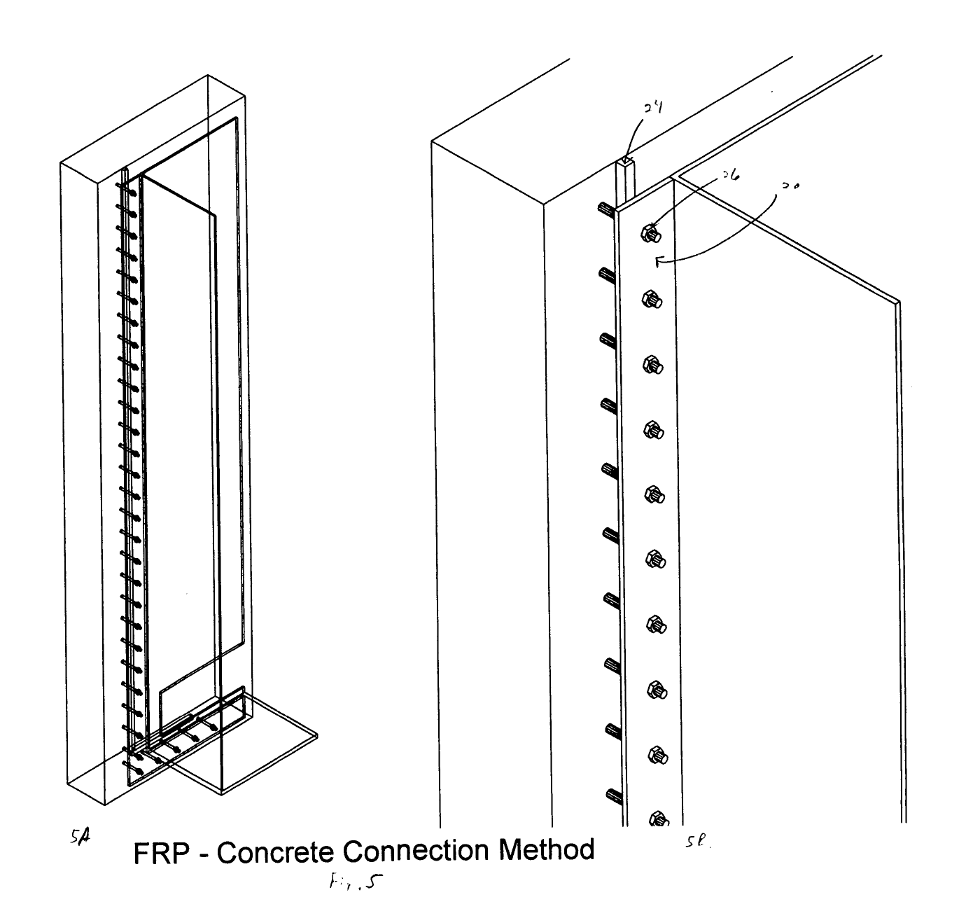

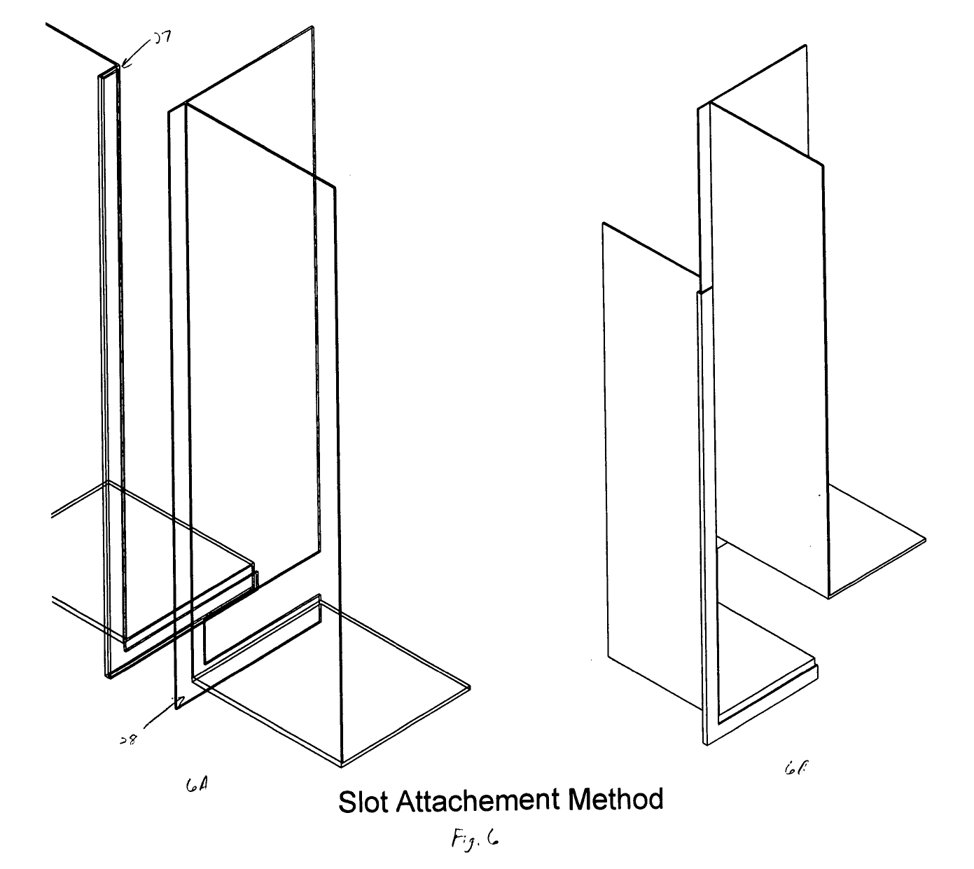

In the preferred embodiment, using fibreglass reinforced plastic housings, each modular filtration unit has a flange 20 incorporated into the housing along the front and back faces. The flanges 20 have bolt holes 22, and when the modular filtration units are aligned for interlocking, the bolt holes in the flanges 20 will align. A gasket 24 is typically placed between the flanges 20, before bolts 26 are inserted into the holes 22 in the flanges 20 and tightened, forming a durable and sealed connection between the two modular filtration units. This attachment technique is illustrated in FIG. 4. In the preferred embodiment, each modular unit housing has an integrated U-shaped flange, with 7/16″ holes on 3″ center, that wraps along the two side walls and the bottom of the modular unit. While a silicone or other pliable sealant may be used to caulk the inside of the tank, in the preferred embodiment a closed cell PVC flexible gasket is attached to the downstream modular unit between the bolt holes 22 and the interior of the housing as the primary means for ensuring a sealed connection. FIG. 5 illustrates a similar technique for connecting a fibreglass reinforced plastic modular unit to a concrete unit. The only difference when using a concrete modular unit is that the bolts are anchored in the concrete, aligned in the same pattern as the bolt holes 22 in the flange 20 of the fibreglass modular unit. FIG. 6 demonstrates an alternative method for interlocking housings, with sliding slotted flanges which may be caulked with sealant. In this variant, the downstream modular unit would have a modified flange with a slot 27, rather than a bolt flange. The upstream modular unit would have a flat faced flange 28 trimmed to meet the inside dimensions of the downstream flange so that it could slide into the slotted flange. The upstream modular unit would then be lowered into position in the slot, and the seam would be caulked using a silicone or some equivalent pliable sealant.

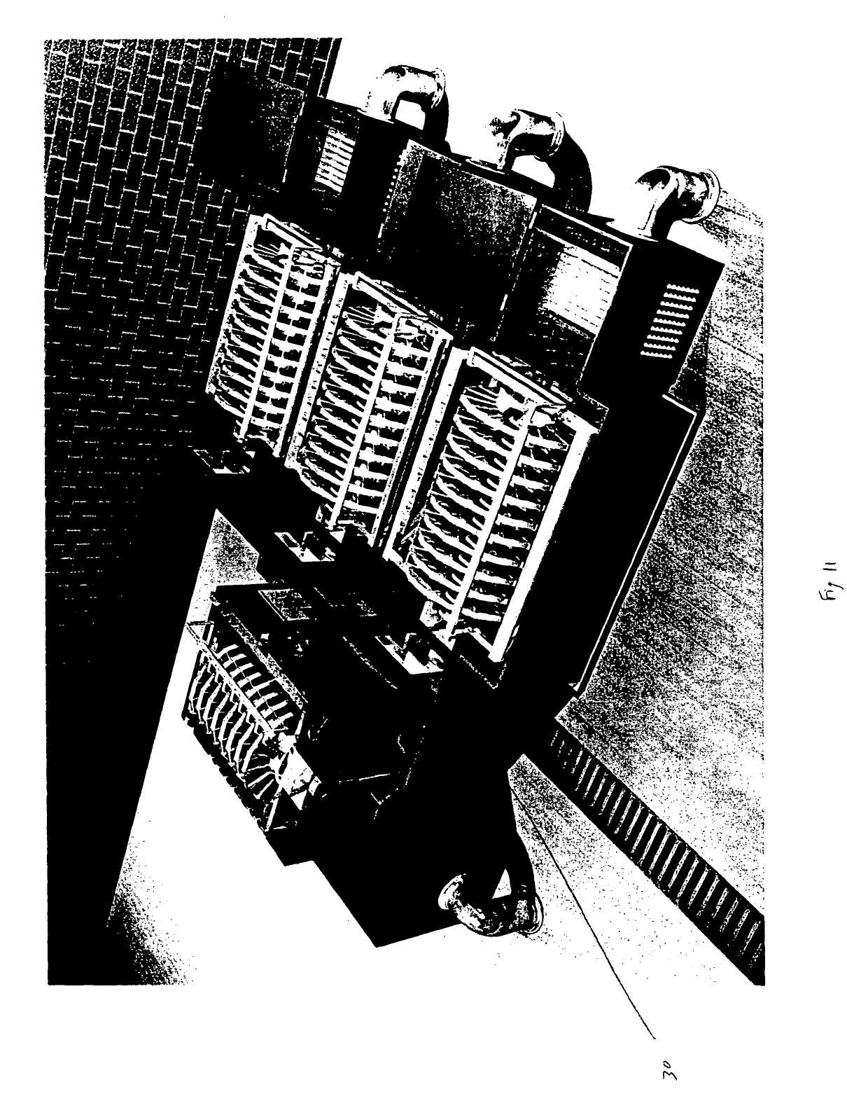

When a plurality of modular filtration units are connected together using any such interlocking technique, they form a customized single cell filtration system (i.e. interlocked housings of the component modular filtration units form a “single volume body” that encompasses all of the water being filtered). The modular, connective nature of the housing for the modular units of the MAFS 10 allows for a plurality of filter configurations and a plurality of filter sizes. Several modular filtration units of the same type could be connected together in order to form a larger filter size, or several different types of modular filtration units could be connected together in different orders to form different filter configurations. Modular filtration units may easily be connected in series, but they may also be connected in parallel, by using a dividing channel 30 of the sort illustrated in FIG. 11. This ability to create a larger effective filter by combining several modular filtration units simplifies installation, while making the upgrade process much smoother. In this way, the MAFS 10 provides a flexible, customizable approach to aquaculture filtration. Modification or upgrading of an existing MAFS 10 filter system could be accomplished by adding modules, without compromising the overall “single volume body.”

Each of the modular filtration units includes within its housing some sort of filtration element. In other words, the internal workings of a particular modular filtration unit would employ one of several known filtration techniques to clean fluid flowing through the unit. While basically any filtration technique could be used within a modular filtration system, typical techniques would include mechanical solids filtration, foam fractionation-protein skimming, carbon dioxide removal, biological filtration (nitrification and de-nitrification), oxygen injection, UV sterilization, Ozone sterilization, and fine solids polishing filtration. Modular filtration units may include these and other filtration techniques. In addition, MAFS 10 may be used in conjunction with other filtration systems, which may be attached to it via conventional piping.

A wide range of filtration techniques are known within the aquaculture industry. While any filtration techniques may be used within the modular filtration units, the preferred embodiment, shown generally in FIGS. 1-3, specifically incorporates a carbon dioxide stripper, a foam fractionator, a biofilter, an optional fine solids polishing filter (shown only in FIG. 2), a UV light sterilizer, and a low head oxygenator. In the preferred embodiment, several of these techniques are actually combined, so that in some instances multiple filtration techniques take place within a single modular filtration unit.

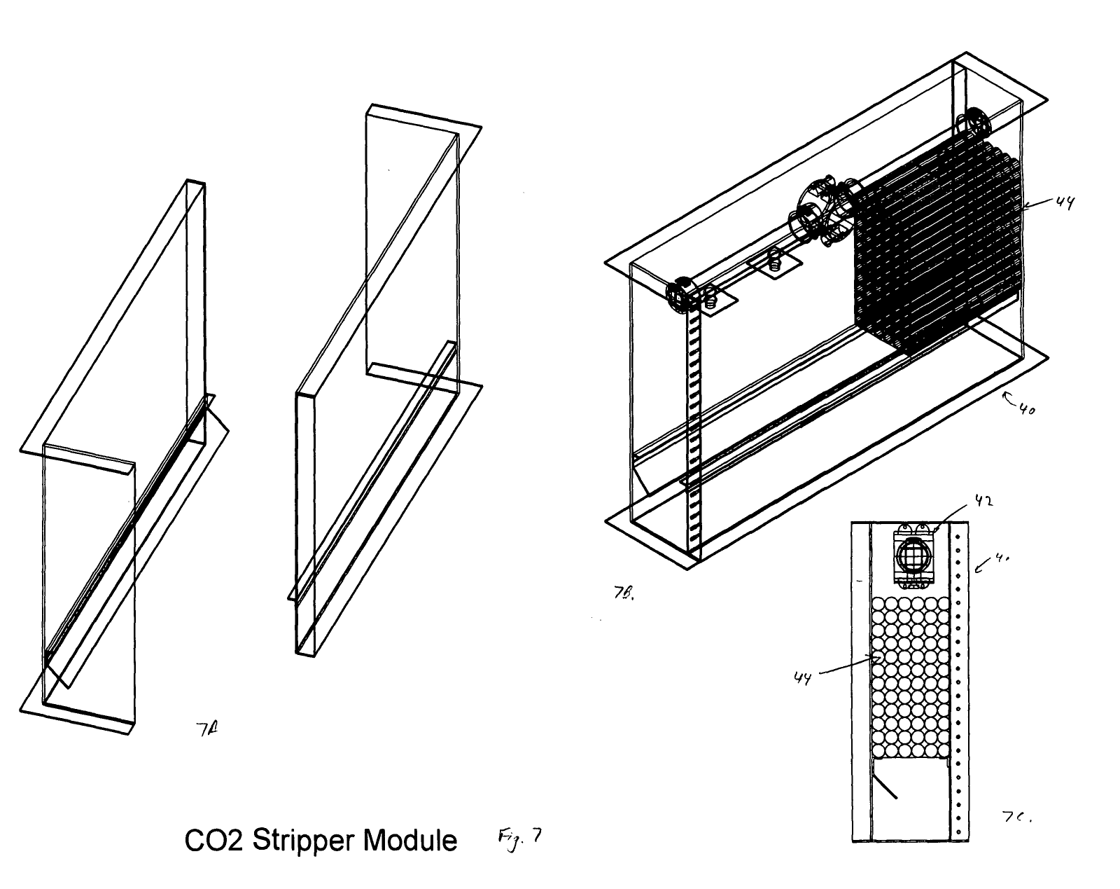

The preferred embodiment of the carbon dioxide stripper 40 is shown in FIG. 7. CO2 is removed from the water by exposing the process flow to an air environment and increasing the surface area of the water to allow for natural equilibrium-based transfer from the water to the air. In the preferred embodiment, water is pumped to a header spraybar 42 atop the unit. The spraybar 42 has a spreader nozzle (with the number for nozzles based on the fluid flow characteristics of the system) that distributes water across the cross-sectional area of the stripper. As water cascades vertically down across the fixed media 44, the exposed surface area for gas removal is increased. A naturally induced air draft is standard, but a forced draft, using a fan, may be used to increase the removal rate.

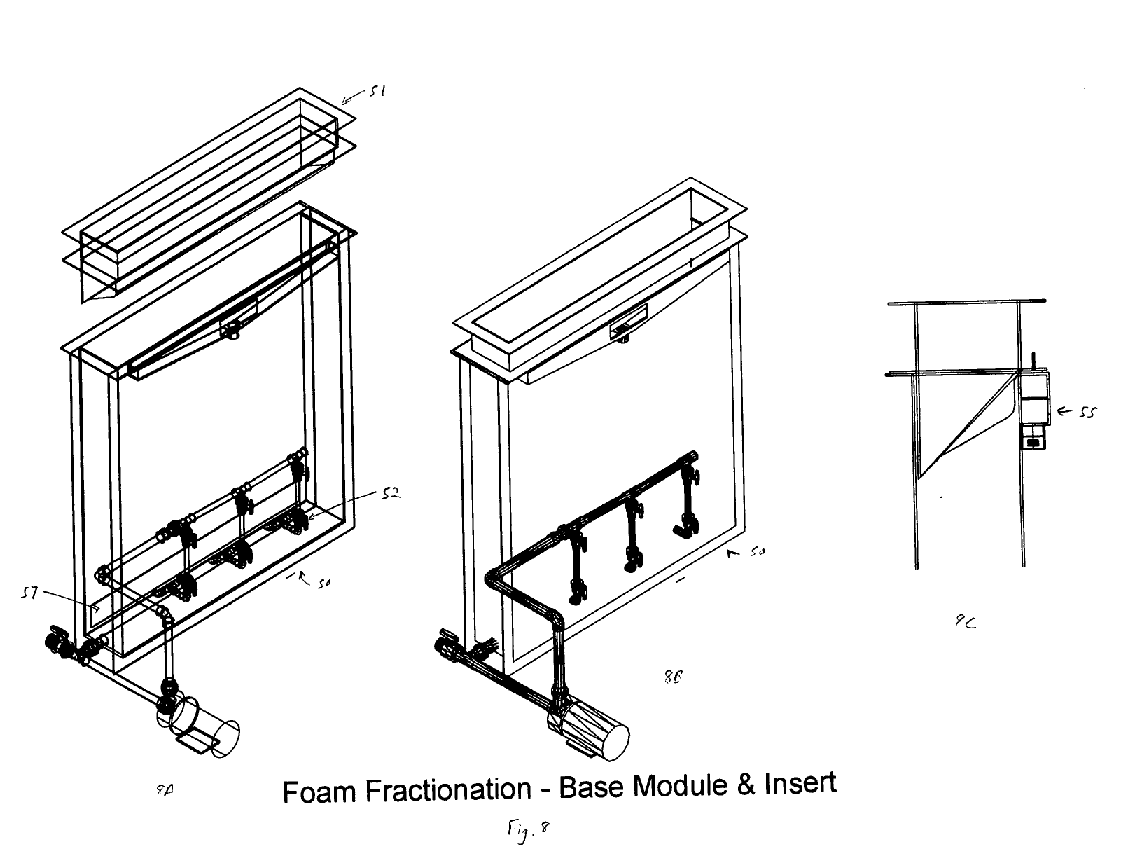

The preferred embodiment of the foam fractionator 50 employs a counter current flow of induced air bubbles. Water enters near the top of the vessel and flows vertically downward through the vessel. An air-water mixture is introduced at or near the bottom of the vessel using venturi injectors 52, causing bubbles to rise vertically, counter-current to the process water flow. The charged surfaces of the bubbles trap dissolved proteins and small solids from the water as they rise, until they burst at the surface, forming a foam that is collected in a foam collection pan 55 for removal from the system. In the preferred embodiment of the MAFS 10, the CO2 stripper 40 and foam fractionator 50 are combined into a single modular filtration unit, so that both filtration techniques can occur within a single housing. This combined unit is shown in FIG. 8.

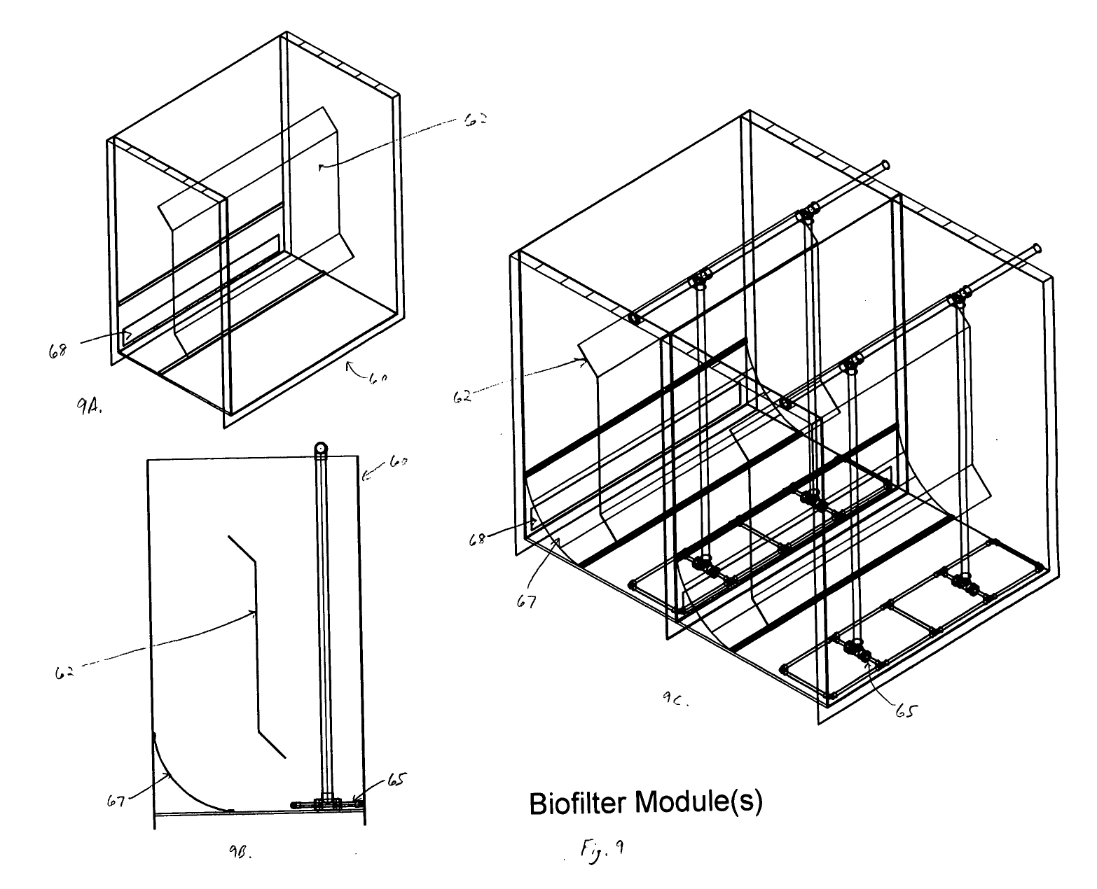

The preferred embodiment of the biofilter 60, shown in FIG. 9, contains a vertical central baffle wall 62 with 45 degree extensions on its top and bottom. The lower angled extension of the central baffle wall 62 extends towards the inlet side of the vessel, while the upper angled extension extends towards the outlet side of the vessel. An air manifold 65 is located on the inlet side of the vessel, and in the preferred embodiment consists of PVC piping with ⅛″ holes. As air bubbles out of the air manifold, it creates an internal vertical water current in the biofilter vessel, such that the water entering the vessel through the inlet flows upward over the central baffle wall before descending on the other side (towards the outlet near the bottom of the vessel). Biofiltration media, typically polyethylene or polystyrene extruded media with surface area no less than 350 m2/m3, is located within the biofilter vessel. A perforated screen 67 covers the outlet 68, preventing the biofiltration media from exiting the biofilter vessel.

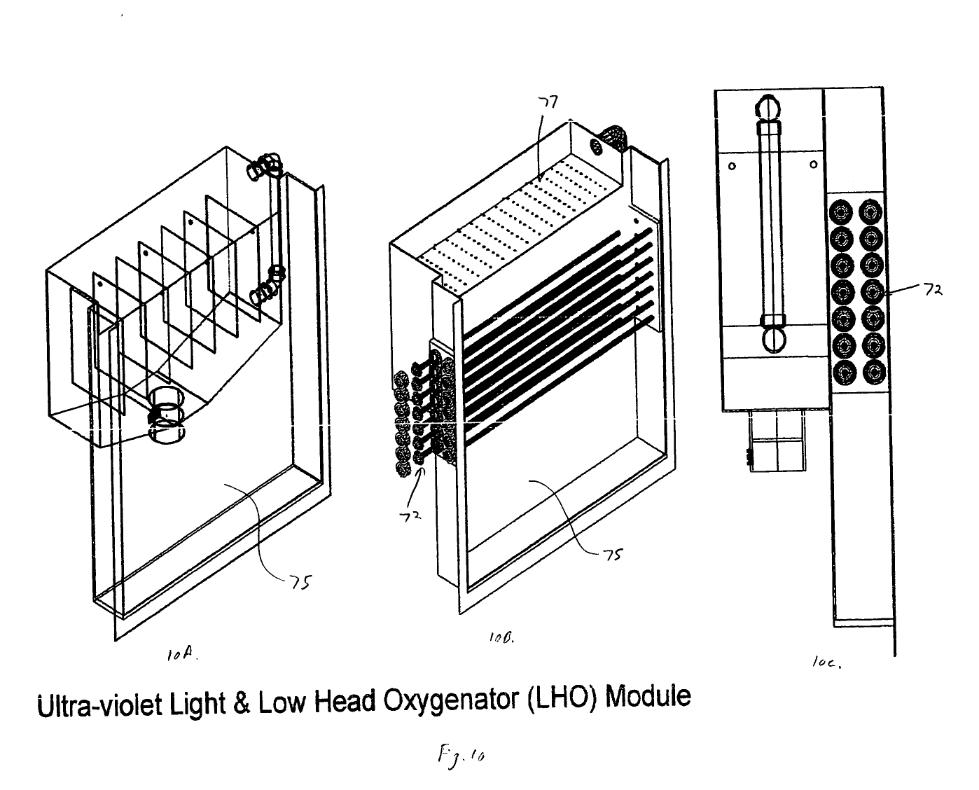

The preferred embodiment of the MAFS 10 combines the UV light treatment channel and the low head oxygenator treatment within a single modular filtration unit, as shown in FIG. 10. The preferred embodiment employs quartz sleeves and UV lamps 72 in the side walls of the vessel oriented in the horizontal plane, so that as the process flow of water passes vertically upward in the vessel, it is treated. A low head oxygenator, as described fully in U.S. Pat. No. 4,880,445, is set on the other side of an internal dividing baffle wall 75 from the UV lamps 72. Thus, the process flow travels vertically upward, through the UV light treatment, before passing onto the LHO distribution plate 77 and downward through the LHO process towards the outlet. The low head oxygenator treatment (“LHO,” i.e. oxygen injection) process uses several vertical columns which are sequentially connected to an oxygen gas source, within a vessel holding the water (all located beneath the LHO distribution plate 77) to displace waste gases.

While the filtration techniques listed above are used in the preferred embodiment, other filtration techniques are also available and may be employed within the modular filtration units or in conjunction with the MAFS 10. Examples of such additional filtration techniques include but are not limited to mechanical filtration, ozone sterilization, and fine solids polishing filtration. Mechanical filtration is typically accomplished using a microscreen drum filter to remove solid particles from the water process flow. Water in the process flow enters the internal chamber of the screened drum and passes through attached screens of various mesh sizes. Solids larger than the mesh openings in the screens are filtered out of the water. A backwash process may be utilized when the screen clogs.

Ozone sterilization uses oxidative reagent ozone in the air induction loop (venturi injectors) and subsequent treatment in the Foam Fractionator. Alternatively, ozone could be applied within the LHO unit. Fine solids polishing filtration employs a chamber housing fixed media, such as that used in the CO2 removal device. Process flow is vertical, from bottom to top across the media, and the fixed media increases the water contact surface area. Biological growth on the media creates a sticky surface area that traps fine solids on the media, and the fine solids in the process flow may also be reduced and consumed by the biological film that exists in this process. These and other filtration techniques are well-known in the aquaculture and other industries, and any such filtration technique may be used as part of or in conjunction with the MAFS 10.

The connective structure of the MAFS 10 allows for many different types of overall filter systems, allowing users to customize the unit for their specific needs. The most typical types of uses for the MAFS 10 within the aquaculture field, however, involve recycling systems and pre-treatment or effluent systems. Recycling systems are attached to aquaculture tanks 90 and regularly and cyclically filter the water in said tanks in a cyclical manner for reuse in the aquaculture tanks 90. Pre-treatment or effluent water treatment systems treat water only once in order to clean it in preparation for discharge. In either case, various filtration modules may be used in various arrangements, depending upon the specific needs of the system being serviced. In this way, the MAFS provides a very flexible filtration approach.

Recycle systems generally utilize a greater range of filtration techniques, since they must effectively remove waste elements from the process flow over a long period of time due to the cyclical nature of these systems (i.e. there is a greater tendency for waste buildup in recycling systems, such that additional filtration may be necessary). By utilizing a variety of filtration techniques in series, a more resilient, redundant, and effective recycle process may occur. Each filtration process acts somewhat differently, so by stacking different types of filtration processes, a more complete filtration is assured. Furthermore, the additional filtration processes may serve as a backstop, allowing the recycle process to run effectively for a longer period of time before filter cleaning may be necessary. Pre-treatment or effluent treatment systems do not expose the same water to contaminants in a repeated fashion, so there is typically not the same need for as many additional filtration techniques in this instance. Rather, pre-treatment or effluent treatment systems are typically designed with only one to three different filtration techniques, as is necessary to ensure a clean effluent for discharge.

The preferred embodiment demonstrating a MAFS 10 configured for a recycle filter flow is shown generally in FIGS. 1 and 2. In this preferred embodiment, five modular filtration units are connected in series, and they are used in a recycle system along with a separate mechanical filtration unit and a pump 85 (for inducing water process flow). The first modular filtration unit of the preferred embodiment contains both a CO2 stripper 40 and a foam fractionator 50 within its housing. This modular filtration unit is attached via flanges 20 and bolts 26 to a biofilter module 60. Two more biofilter modules 60 are connected in series downstream to the first biofilter module 60 in the preferred embodiment, using flanges 20 and bolts 26, and a final modular filtration unit, containing both a UV light source 72 and a low head oxygenator filter 77 within its housing, is attached to the last biofilter module 60 using flanges 20 and bolts 26. By design, the housing of the initial modular filtration unit includes an additional back wall, as does the final modular filtration unit, so that when all of the modular filtration units are linked together, they form a single cell system (i.e. a closed system within a “single volume body”). FIG. 2 also shows an optional fine solids polishing filter.

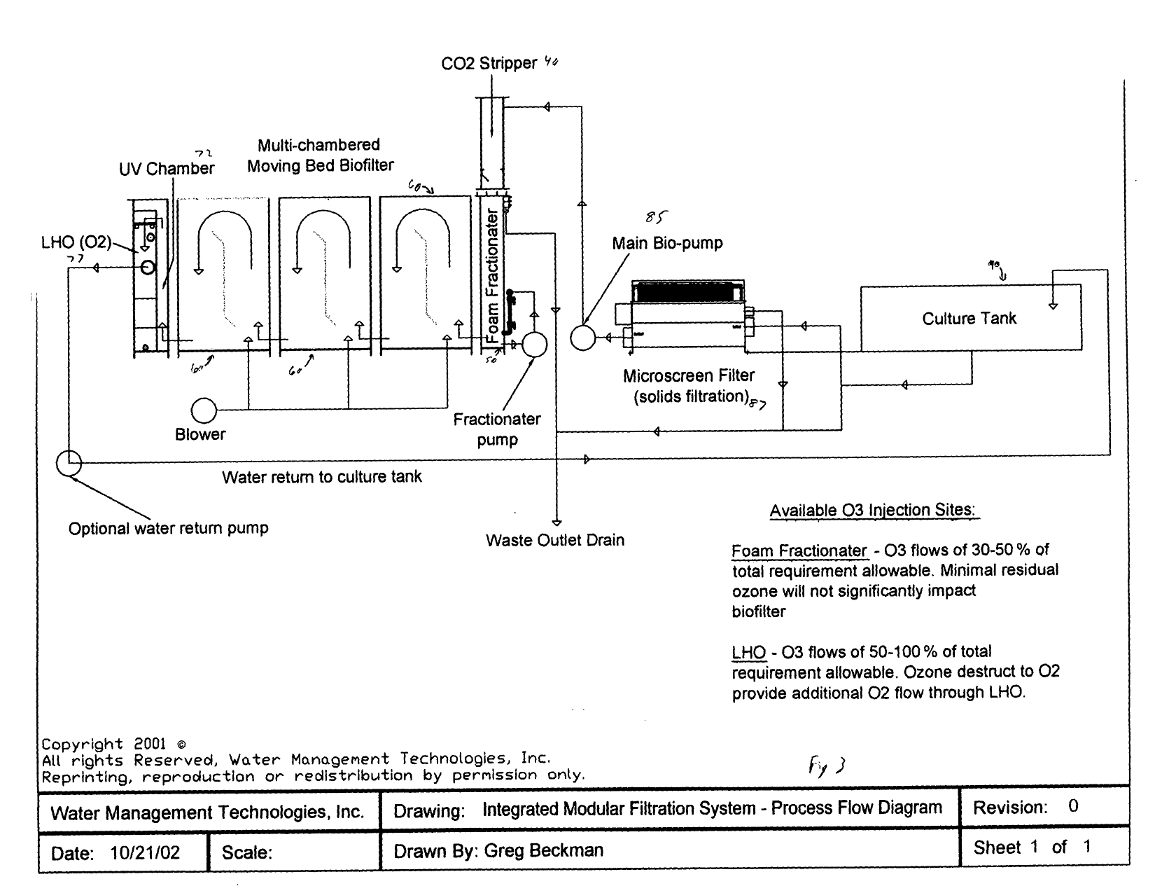

FIG. 3 shows the process flow of the water through the preferred embodiment described above. Initially, the water process flow leaves the aquaculture tank 90 and flows through a separate microscreen filter 87, which serves to provide mechanical filtration of solids from the water. A pump 85 draws the water from the microscreen filter 87 into the first modular filtration unit, which includes both a CO2 stripper 40 and a foam fractionator 50. The water proceeds through the CO2 stripper 40, exiting the header spraybar 42 atop the unit and cascading vertically down across the fixed media 44. This increases the exposed surface area for gas removal, by an induced air draft. The process flow of water then proceeds downward into the top of the foam fractionator 50, and flows vertically downward through the foam fractionator vessel. As the water flow enter the foam fractionator unit 50, it falls into an angled funnel insert 51. The mouth of this funnel insert 51, shown in more detail in FIG. 8C, directs the entering water to one side of the vessel, while the underside of the funnel insert 51 traps and deflects the foam away from the mouth and the entering water process flow and towards the foam collection pan 55. An air-water mixture is introduced at or near the bottom of the vessel, using a pump, causing induced air bubbles to rise in an vertical counter-current. The charged surfaces of the bubbles trap dissolved proteins and small solids from the water as they rise, until they burst at the surface, forming a foam that is collected in a foam collection pan 55 for removal from the system. The water process flow continues on to the next modular filtration unit through a slot/hole 57 in the wall near the bottom of the foam fractionator vessel.

In the preferred embodiment of the MAFS 10, the process flow then enters a series of biofilter modules 60. In the preferred embodiment, three consecutive biofilter modules 60 are employed. The use of multiple biofiltration modules 60 creates a long path plug flow filter. The water process flow from the foam fractionator enters the biofilter module 60 through an inlet slot or hole near the bottom of the upstream side of the modular filtration unit vessel. The biofilter module 60 contains a vertical central baffle wall 62 with 45 degree extensions on its top and bottom. The lower angled extension of the central baffle wall 62 extends towards the inlet side of the vessel, while the upper angled extension extends towards the outlet side of the vessel. These angled extensions of the central baffle wall 62 act to help direct the process flow within the biofilter module 60. An air manifold 65 is located on the inlet side of the vessel, and in the preferred embodiment consists of PVC piping with ⅛″-1/16″ holes. As air bubbles out of the air manifold 65, it creates an internal vertical water current in the biofilter vessel 60, such that the water entering the vessel through the inlet flows upward over the central baffle wall 62 before descending on the other side (towards the outlet 68 near the bottom of the vessel). Biofiltration media, typically polyethylene or polystyrene extruded media with surface area no less than 350 m2/m3 (i.e. the biofiltration media has a combined surface area of no less than 350 square meters per cubic meter of volume space in the biofilter), is located within the biofilter vessel. A perforated screen 67 covers the outlet slot or hole 68 on the downstream side of the vessel (located near the bottom of the vessel), preventing the biofiltration media from exiting the biofilter vessel 60. In the preferred embodiment, the perforated screen 67 is retained by clips, such that it may be easily removed for cleaning.

The same structure and process flow applies for each of the biofilter modules 60. Thus, the water process flow enters each of the biofilter modules 60 through the inlet on the upstream side of the vessel near the bottom of the vessel. The water process flow then encounters the air bubbles from the air manifold 65, and the rising air bubbles, along with the deflection action of the central baffle 62, causes the water process flow to proceed upward in the biofilter module 60, over the central baffle 62, before descending down to pass through the perforated screen 67 and exit out the outlet 68 located near the bottom of the vessel on the downstream side of the biofilter module vessel 60. So, there is a vertical water current within each biofilter module 60 which mixes the media in a circular pattern, in a vertical plane, around the central baffle 62.

Finally, the water process flow leaves the third biofilter module 60 through the outlet slot 68 and enters the final modular filtration unit, which contains the ultraviolet light treatment and low head oxygenation treatment. This modular filtration unit is divided into two distinct parts by an internal vertical baffle wall 75. The UV treatment is contained in the first chamber, while the LHO (oxygen injection) treatment is contained within the second chamber. The water enters through the inlet located near the bottom of the UV treatment chamber, and then proceeds upward. As the water process flow travels vertically upward in the UV Treatment chamber, it will be exposed to UV light, since there are UV lamps 72 running horizontally throughout the UV treatment chamber. Near the top of the modular filtration unit, the water process flow will seep over, through an indentation in the internal vertical baffle wall 75, into the LHO treatment chamber. A water distribution plate 77, located near the top of the LHO treatment chamber will diffuse the water out into the LHO chamber for treatment. The water will then progress downward through the vertical columns of the LHO chamber, being exposed to oxygen gas in the process so that the waste gas displacement process described in U.S Pat. No. 4,880,445, and incorporated herein, may occur. Finally, the water exits the LHO treatment chamber of the final modular filtration unit and is recirculated back to the aquaculture tank 90.

While the preferred embodiment of the MAFS 10 shown in FIGS. 1-3 is configured as a recycle system, the MAFS 10 may also be used to treat effluent. These types of effluent pretreatment systems may combine any types of filtration, but typically use one or more of mechanical filtration, fine solids filtration, UV and Ozone filtration techniques. FIG. 11 is an illustration of a MAFS 10 configured as a pre-treatment or effluent treatment system, using mechanical solids filtration in conjunction with UV sterilization and LHO filtration.

In either the recycle configuration or the configuration for pre-treatment or effluent treatment, a variety of modular filtration units may be used. Order is typically not crucial, having little effect on the overall filtration process, but if used, mechanical filtration is typically the first filtration process, since this makes later filtration more productive, while oxygen injection is generally the last filtration process in an aquaculture system, since this maximizes oxygen content by preventing oxygen loss during other treatment stages. Size is dependent on the volume of water that needs to be filtered, the cycle time, and the biological parameters of the aquaculture tank at issue, and additional modular filtration units of each type may be added in parallel or in series in order to allow the MAFS 10 to process more fluid per unit time. These factors are well-known within the aquaculture industry, and the MAFS 10 can be used accordingly.

While the present invention is particularly well-suited to aquaculture filtration, it is in no way limited to this field, and the modular approach of the MAFS 10 may be used in other fields and for other purposes. In addition, the particular configurations of the preferred embodiment described above are merely illustrative; a person skilled in the art field will recognize and understand that other configurations are equally possible and effective and may be used in place of the preferred embodiments illustrated above. The modular nature of the MAFS 10 lends itself to customization, and the specific types and number of modular filtration units chosen, along with the order of the process flow, can be set according to the specific needs of the task at hand. Persons skilled in the art field will understand that the scope of the present invention is not limited to the preferred embodiments, but is intended to include all variants of the MAFS 10 for any and all uses. The scope of the present invention is more fully set forth in the claims section below.

We claim:

1. A filtration system comprising a plurality of modular filtration units, wherein each of said modular filtration units further comprises:
a housing;
a means for interlocking one of said modular filtration units to another modular filtration unit; and
a filtration element.

2. A filtration system as in claim 1 wherein said plurality of modular filtration units interlock together to form a single cell filtration system.

3. A filtration system as in claim 1 wherein said means for interlocking modular filtration units further comprises:
flanges on each of said modular filtration units;
a means for sealing a joint; and
a means for joining.

4. A filtration system as in claim 3 wherein said means for joining further comprises one or more bolts.

5. A filtration system as in claim 4 wherein said means for sealing is a gasket.

6. A filtration system as in claim 3 wherein said means for joining further comprises mating sliding-slotted flanges.

7. A filtration system as in claim 6 wherein said means for sealing is caulking.

8. A filtration system as in claim 1 wherein said housing is constructed of fibreglass reinforced plastic.

9. A filtration system as in claim 3 wherein said housing is constructed of fibreglass reinforced plastic.

10. A filtration system as in claim 1 wherein said filtration element for at least one of said modular filtration units further comprises a biofilter.

11. A filtration system as in claim 1 wherein said filtration element for at least one of said modular filtration units further comprises a carbon dioxide stripper.

12. A filtration system as in claim 1 wherein said filtration element for at least one of said modular filtration units further comprises a foam fractionator.

13. A filtration system as in claim 1 wherein said filtration element for at least one of said modular filtration units further comprises a low head oxygenator.

14. A filtration system as in claim 1 wherein said filtration element for at least one of said modular filtration units further comprises a UV light sterilization filter.

15. A filtration system as in claim 1 wherein said filtration element for at least one of said modular filtration units further comprises a mechanical solids filter.

16. A filtration system as in claim 1 wherein said filtration element for at least one of said modular filtration units further comprises a fine solids polishing filter.

17. A filtration system as in claim 1 wherein at least one of said modular filtration units further comprises a second filtration element, wherein said first filtration element further comprises a carbon dioxide stripper and said second filtration element further comprises a foam fractionator.

18. A filtration system as in claim 1 wherein at least one of said modular filtration unit further comprises a second filtration element, wherein said first filtration element further comprises a UV light sterilization filter and said second filtration element further comprises a low head oxygenator.

19. A filtration system as in claim 10 wherein said biofilter further comprises a vertical central baffle wall, an air manifold, and biofiltration media.

20. A filtration system as in claim 19 wherein said biofilter further comprises and inlet, and wherein:
said central baffle wall further comprises a 45 degree extension on the bottom of said baffle wall directed towards said inlet and a 45 degree extension on the top of said baffle wall directed away from said inlet;
said biofiltration media has a surface area no less than 350 m2/m3; and
said air manifold is located near said inlet.

21. A filtration system as in claim 20 wherein said biofiltration media is constructed of extruded polyethylene.

22. A filtration system as in claim 20 wherein said biofiltration media is constructed of extruded polystyrene.

23. A filtration system as in claim 20 wherein said biofilter further comprises an outlet and a retaining screen.

24. A filtration system comprising two or more modular filtration units, wherein each of said modular filtration units comprises a housing and a filtration element.

25. A filtration system as in claim 24 wherein said housing further comprises a means for interlocking said housing to the housing of another modular filtration unit.

26. A filtration system as in claim 25 wherein said modular filtration units interlock to form a single volume body.

27. A filtration system as in claim 26 wherein said means for interlocking modular filtration units further comprises:
flanges on each of said modular filtration units;
a sealant; and
a means for joining.

28. A filtration system as in claim 27 wherein said means for joining further comprises one or more bolts, wherein said sealant further comprises a gasket, and wherein said housing is constructed of fibreglass reinforced plastic.

29. A filtration system as in claim 27 wherein said filtration element for at least one of said modular filtration units further comprises a biofilter.

30. A filtration system as in claim 29 wherein said biofilter further comprises an inlet, an outlet, a vertical central baffle wall, an air manifold, a retaining screen, and biofiltration media.

31. A filtration system as in claim 30 wherein:
said central baffle wall further comprises a 45 degree extension on the bottom of said baffle wall directed towards said inlet and a 45 degree extension on the top of said baffle wall directed away from said inlet;
said air manifold is located adjacent to said inlet;
said biofiltration media is constructed of extruded polymer; and
said retaining screen covers said outlet.

32. A filtration system as in claim 31 wherein said biofiltration media has a surface area no less than 350 m2/m3.

33. A filtration system comprising a biofilter, wherein said biofilter further comprises an inlet, an outlet, a vertical central baffle wall, an air manifold, a retaining screen, and biofiltration media.

34. A filtration system as in claim 33 wherein:
said central baffle wall further comprises a 45 degree extension on the bottom of said baffle wall directed towards said inlet and a 45 degree extension on the top of said baffle wall directed away from said inlet;
said biofiltration media has a surface area no less than 350 m2/m3;
said air manifold is located near said inlet; and
said retaining screen covers said outlet.

35. A filtration system as in claim 34 wherein said biofiltration media is constructed of extruded polymer.

36. A filtration system as in claim 35 wherein said biofiltration media is constructed of extruded polystyrene.

37. A filtration system as in claim 35 wherein said biofiltration media is constructed of extruded polyethylene.

38. A filtration system as in claim 35 further comprising a plurality of modular filtration units, wherein each of said modular filtration units further comprises:
a housing;
a means for interlocking one of said modular filtration units to another modular filtration unit; and
a filtration element; and
wherein said filtration element for at least one of said modular filtration units is said biofilter.
